(19) United States
(12) Patent Application Publication
(10) Pub. No.: US 2011/0233878 A1
(43) Pub. Date: Sep. 29, 2011

(54) Hand-held power tool

(76) Inventors: Mohsein Wan, Bukit Mertajam (MY); Chun How Low, Tanjong Bunghah (MY); Siew Yuen Lee, Bayan Lepas (MY); Chun Chee Loh, Bayan Lepas (MY)

(21) Appl. No.: 12/929,935

(22) Filed: Feb. 25, 2011

(30) Foreign Application Priority Data
Feb. 25, 2010 (DE) 10 2010 002 352.3

(51) Int. Cl. B23B 31/107

(52) U.S. Cl. 279/76; 279/9.1

(57) ABSTRACT

In a hand-held power tool having a tool holder equipped with a multisided internal socket for connecting to a first insert bit and with a multisided external socket for connecting to a second insert bit, the tool holder being associated with a locking device for locking the first insert bit in the multisided internal socket, the locking device has an actuating element that it is possible to slide from a locking position into an unlocking position in an axial direction oriented away from the first insert tool in order to unlock the first insert tool.

### CROSS-REFERENCE TO RELATED APPLICATION

This application is based on German Patent Application 10 2010 002 352.3 filed on Feb. 25, 2010.

### BACKGROUND OF THE INVENTION

1. Field of the Invention

The present invention relates to a hand-held power tool having a tool holder equipped with a multisided internal socket for connecting to a first insert bit and with a multisided external socket for connecting to a second insert bit. The tool holder is associated with a locking device for locking the first insert bit in the multisided internal socket.

2. Description of the Prior Art

EP 2 039 449 A1 has disclosed a hand-held power tool of this kind embodied in the form of a rotary impact wrench, which has a tool holder that can be connected not only to an insert bit with an external multisided coupling such as a screwdriver bit but also to an insert bit with an internal multisided coupling such as a socket wrench. In order to attach a screwdriver bit to the tool holder, a locking device is provided in which an actuating sleeve in an associated locking position presses radially inward against retaining balls through openings provided in the tool holder so that the retaining balls engage in a groove embodied on the external multisided coupling of the screwdriver bit, thus locking the screwdriver bit in the multisided internal socket of the tool holder. An associated compression spring prestresses the actuating sleeve in an axial direction oriented away from the screwdriver bit and, in order to unlock the screwdriver bit, the actuating sleeve must be slid axially toward the screwdriver bit in opposition to the force of this spring to permit a release of the retaining balls.

The prior art has the disadvantage that maneuvering the hand-held power tool when actuating the actuating sleeve is cumbersome and complicated, resulting in reduced convenience in the use of such a hand-held power tool.

### OBJECT AND SUMMARY OF THE INVENTION

The object of the invention, therefore, is to produce a new hand-held power tool that has a tool holder equipped with a locking device that permits a simple, rapid unlocking of an insert bit with an external multisided coupling.

This object is attained by means of a hand-held power tool having a tool holder that is equipped with a multisided internal socket for connecting to a first insert bit and with a multisided external socket for connecting to a second insert bit. The tool holder is associated with a locking device for locking the first insert bit in the multisided internal socket. The locking device has an actuating element that can be slid from a locking position into an unlocking position in an axial direction oriented away from the first insert tool in order to unlock the first insert tool.

The invention therefore makes it possible to produce a hand-held power tool that is easy and safe to maneuver when unlocking an insert bit with an external multisided coupling.

The locking device preferably has a spring element that is embodied to act on the actuating element toward the locking position with a predetermined spring force in the direction of the insert bit.

It is thus possible to produce a locking device in which the spring element reliably secures the actuating element in the locking position.

The actuating element preferably has an actuating sleeve that at least partially encompasses tool holder.

It is thus possible to produce a simple, inexpensive actuating element.

The locking device preferably has a retaining element that is embodied to block the actuating element, which the spring element acts on with the predetermined spring force, in the locking position during operation of the hand-held power tool.

It is thus possible to achieve a safe, stable blocking of the actuating element in the locking position.

According to one embodiment, the retaining element is embodied in the form of a C-ring that has radial extensions for blocking the actuating element.

The invention thus makes it possible to produce an inexpensive, reliable retaining element.

The actuating element preferably has a collar-like supporting element, which, in the locking position, rests against the radial extensions of the retaining element.

Consequently, the retaining element can block the actuating element in the locking position in a simple way.

The spring element is preferably situated between a shoulder, which is associated with the tool holder, and at least one projection provided on the actuating element.

The invention therefore enables an uncomplicated, stable design of the locking device.

According to one embodiment, the locking device has at least one locking element, which, in the locking position, is acted on by the actuating element in the direction toward the multisided internal socket in order to lock the first insert bit.

It is thus possible to achieve a simple, reliable locking of the insert bit in the multisided internal socket.

The at least one locking element is preferably embodied to engage in an external groove-like recess in the first insert bit, the recess being provided on an external multisided coupling of the first insert bit, which can be slid into the multisided internal socket of the tool holder.

It is thus possible to produce a secure, stable connection between the locking element and the insert bit.

The at least one locking element is preferably embodied in the form of a ball.

The invention consequently makes it possible to produce an inexpensive locking element.

According to one embodiment, the multisided external socket has a fastening element to which the second insert bit, which is provided with an internal multisided coupling, can be fastened by means of an associated pin.

The invention therefore makes it possible for insert bits equipped with an internal multisided coupling and embodied in accordance with Japanese industrial standards to be simply and quickly attached to the tool holder.

The object mentioned at the beginning is also attained by means of a tool holder having a multisided internal socket for connecting to a first insert bit and a multisided external socket for connecting to a second insert bit. The tool holder is associated with a locking device for locking the first insert bit in the multisided internal socket. The locking device has an actuating element that can be slid from a locking position into an unlocking position in an axial direction oriented away from the first insert tool in order to unlock the first insert tool.

The invention will be better understood and further objects and advantages thereof will become more apparent from the ensuing detailed description of preferred embodiments taken in conjunction with the drawings.

### BRIEF DESCRIPTION OF THE DRAWINGS

In the drawings:

FIG. 1 is a schematic view of a hand-held power tool with an insert bit according to a first embodiment;

FIG. 2 is a perspective, exploded view of the output shaft, with the tool holder from FIG. 1 and a locking device according to one embodiment during assembly;

FIG. 3 is a perspective view of the output shaft with the tool holder and the locking device from FIG. 2 after assembly;

FIG. 4 is a sectional view of the output shaft with the tool holder and locking device from FIGS. 2 and 3, with an insert bit equipped with an internal multisided coupling and embodied in accordance with Japanese industrial standards; and

FIG. 5 shows an enlarged detail from FIG. 4

### DESCRIPTION OF THE PREFERRED EMBODIMENTS

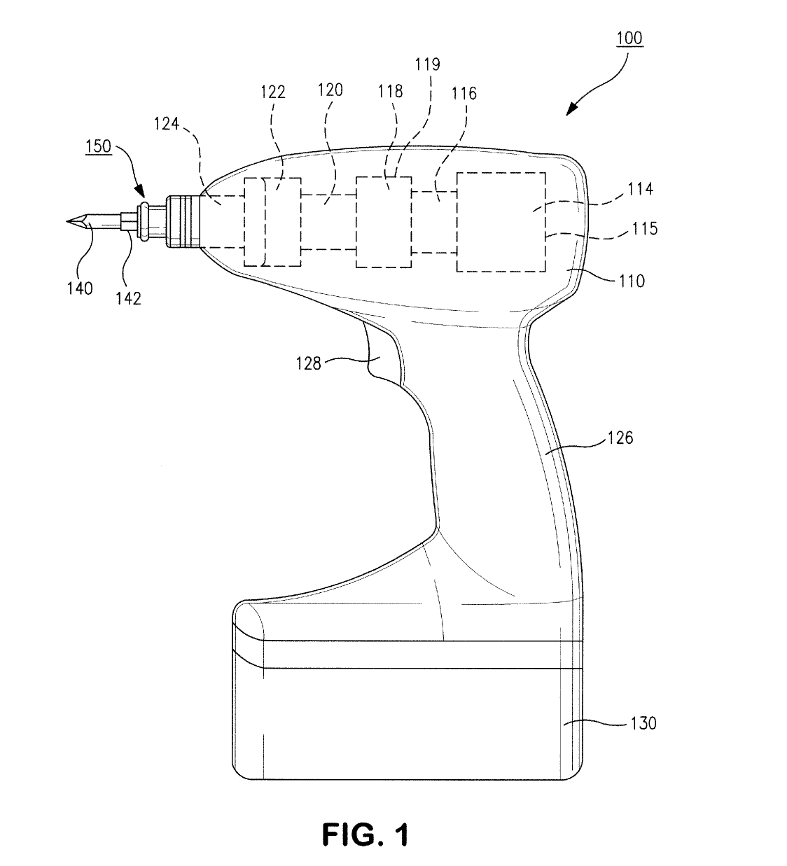

FIG. 1 shows a hand-held power tool 100 that is provided with a tool holder 150 and has a housing 110 with a handle 126. According to one embodiment, the hand-held power tool 100 can be mechanically and electrically connected to a battery pack 130 as a cordless power supply.

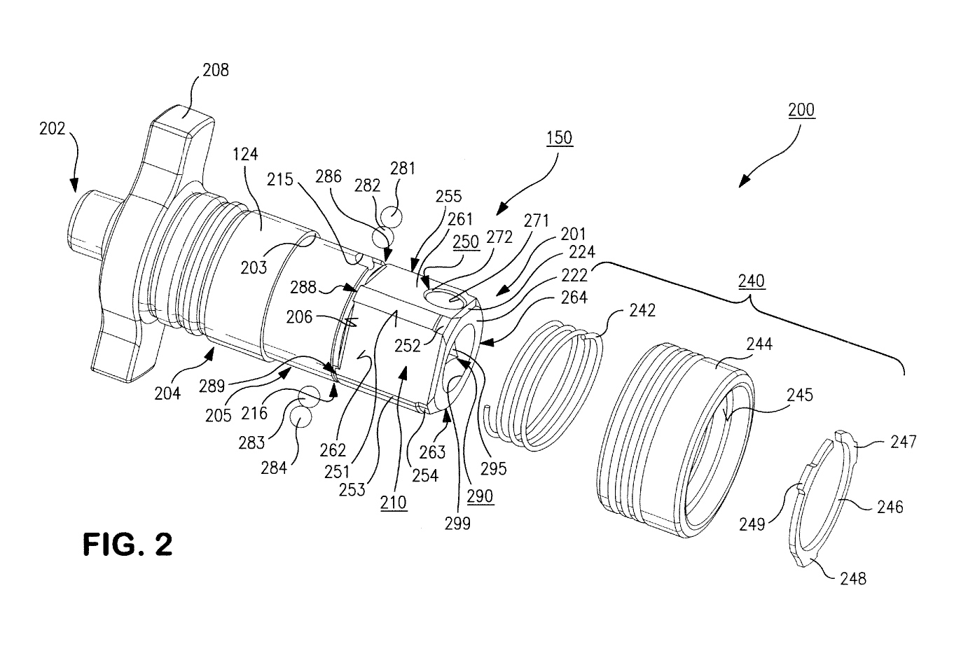

For example, the hand-held power tool 100 is embodied in the form of a cordless rotary impact wrench. It should be noted, however, that the present invention is not limited to cordless rotary impact wrenches, but can instead be used in a variety of power tools in which a tool bit is set into rotation, e.g. a screwdriver, a drill/driver, an impact drill, etc., independent of whether the power tool can be cordlessly operated by means of a battery pack or operated in a corded fashion. It should also be noted that the present invention is not limited to motor-driven hand-held power tools, but can be used generally in tools in which the tool holder 150 described in conjunction with FIGS. 2 through 5 can be used.

The housing 110 contains an electric drive motor 114 that is supplied with current by the battery pack 130, a transmission 118, and an impact mechanism 122. The drive motor 114 can be actuated, i.e. switched on and off, by means of a manual switch 128, for example, and can be any type of motor, e.g. an electronically commutated motor or a direct current motor. Preferably, the drive motor 114 can be electronically controlled or regulated so that it is possible to achieve reversible operation and to fulfill requirements relating to a desired rotation speed. The operation and design of a suitable drive motor are sufficiently known from the prior art so that for the sake of brevity, a detailed description is not given here.

The drive motor 114 is connected via an associated motor shaft 116 to the transmission 118, which converts a rotation of the motor shaft 116 into a rotation of a drive shaft 120 provided between the transmission 118 and impact mechanism 122. This conversion preferably occurs so that relative to the motor shaft 116, the drive shaft 120 rotates with an increased torque but a decreased rotation speed. For the sake of illustration, the drive motor 114 is situated in a motor housing 115 and the transmission 118 is situated in a transmission housing 119; the transmission housing 119 and motor housing 115 are situated in the housing 110, for example.

For example, the impact mechanism 122 connected to the drive shaft 120 is a rotating impact mechanism that produces impact-like high-intensity angular impulses and transmits them to an output shaft 124, e.g. an output spindle. The tool holder 150 is provided on the output shaft 124; it is preferably embodied to accommodate insert bits and according to one embodiment, can be connected to an insert bit 140 with an external multisided coupling 142 as well as to an insert bit with an internal multisided coupling manufactured in accordance with Japanese industrial standards (e.g. the socket wrench 510 in FIG. 4). For example, the insert bit 140 is embodied in the form of a screwdriver bit with an external multisided coupling 142, e.g. a hexagonal coupling, situated in a suitable internal socket (290 in FIG. 2) of the tool holder 150. A screwdriver bit of this kind is sufficiently known from the prior art so that for the sake of brevity, a detailed description is not given here.

FIG. 2 shows an arrangement 200 with the output shaft 124 and the tool holder 150 from FIG. 1 as well as an actuatable locking device 240 according to one embodiment. The output shaft 124 has a distal end region 201 and a proximal end region 202 provided with an output cam 208; this proximal end region is connected to the impact mechanism 122 of the hand-held power tool 100 in FIG. 1. The output shaft 124 is provided with a tool holder 150, which is provided for example with an external socket 210 and an internal socket 290 and as an illustrative example, is formed onto the output shaft 124, preferably embodied of one piece with it.

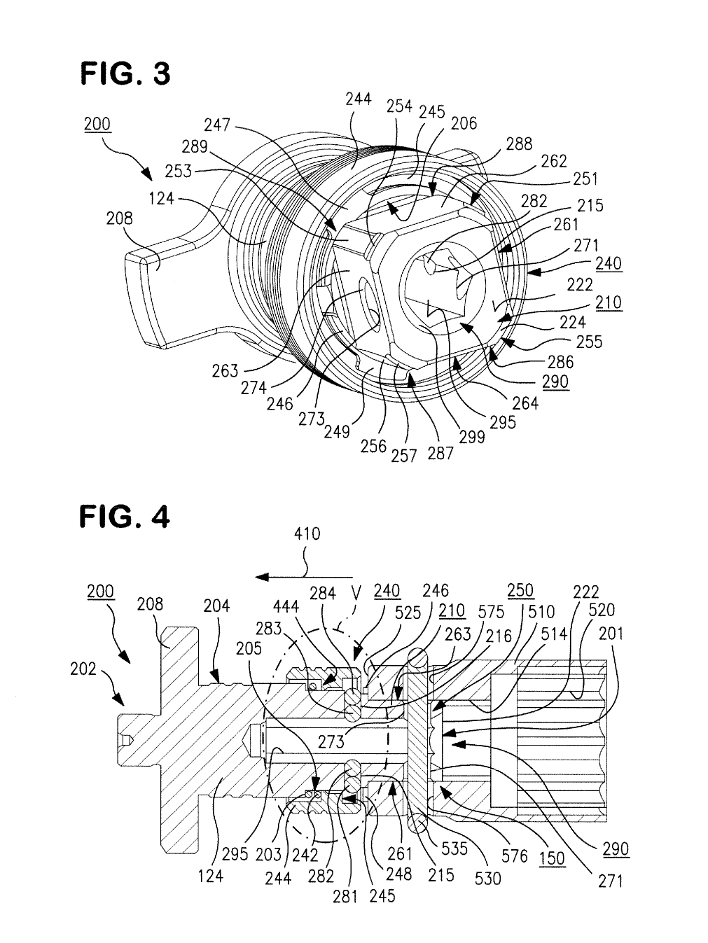

According to one embodiment, starting from the output cam 208 in the direction toward the distal end region 201, the output shaft 124 has a first preferably cylindrical section 204 with a first diameter D1. At a first shoulder 203, the shaft 124 narrows and transitions into a second cylindrical section 205 with a second diameter D2, where D2<D1. At a second shoulder 206, the shaft 124 narrows again and transitions into the external socket 210, which in turn transitions via a bevel 224 into a distal end surface 222. In the region of the second shoulder 206, at least one radial opening 215 is embodied in the second cylindrical section 205. For example, a second opening 216 is provided diametrically opposite from the opening 215. In the region between the second shoulder 206 and the external socket 210, at least one groove-like recess 288 is provided. For example, four groove-like recesses 286, 287 (FIG. 3), 288, 289 are provided.

For example, the external socket 210 is a multisided external socket, preferably a four-sided external socket that has for example four preferably planar side surfaces 261, 262, 263, 264 in the radial direction. For example, the four-sided external socket 210 has a fastening element 250 for fastening an insert bit equipped with an internal multisided coupling and manufactured in accordance with Japanese industrial standards (e.g. the socket wrench 510 in FIG. 4) to the tool holder 150. The fastening element 250 has conically stepped openings that are provided in at least two opposing side surfaces and are embodied to allow a pin (530 in FIG. 4) to pass through. As an illustrative example, the side surface 261 is provided with an opening 271 having a conical section 272. The side surface 263 is provided with an opening 273 (FIG. 3) having a conical section 274 (FIG. 3).

The side surfaces 261, 262, 263, 264 are connected to one another by means of beveled edges, e.g. the surfaces 261, 262 are connected to each other by means of a beveled edge 251, the surfaces 262, 263 are connected to each other by means of a beveled edge 253, and the surfaces 261, 264 are connected to each other by means of a beveled edge 255. The beveled edges have end surfaces that are beveled toward the distal end region 201 of the output shaft 124, e.g. the edges 251 and 253 have the respective beveled end surfaces 252 and 254. The beveled end regions 252, 254, the beveled edges 251, 253, 255, and the bevel 224 are preferably embodied to facilitate sliding a corresponding insert bit with an internal multisided coupling onto the four-sided external socket 210.

The distance between opposing beveled edges, e.g. between the edges 251 and 256 or 253 and 255 preferably corresponds approximately to the diameter D2 of the second section 205 of the output shaft 124 so that groove-like recesses 288, 289, 286 (FIG. 3), and 287 (FIG. 3) are formed between the beveled edges 251, 253, 255, 256 (FIG. 3) and the second shoulder 206. The distance between opposing side surfaces of the four-sided external socket 210, i.e. the distance between the side surfaces 261 and 263 or the distance between the side surfaces 262 and 264 is for example smaller than the diameter D2 and is preferably predetermined so that no recesses are formed between the side surfaces 261, 262, 263, 264 and the shoulder 206. It is, however, likewise possible for groove-like recesses to also be formed between the side surfaces 261, 262, 263, 264 and the shoulder 206, which recesses can also form an annular groove together with the groove-like recesses 288, 289, 286 (FIG. 3), and 287 (FIG. 3).

According to one embodiment, the internal socket 290 of the tool holder 150 is embodied in the form of a multisided internal socket on the inside of the output shaft 124 and serves to accommodate the insert bit 140 from FIG. 1. As an illustrative example, the internal socket 290 has a hexagonal internal profile 310, as depicted in FIG. 3. The internal socket 290 is associated with the locking device 240, which can be actuated by means of an actuating element 244 preferably embodied in the form of an actuating sleeve in order to lock the insert bit 140.

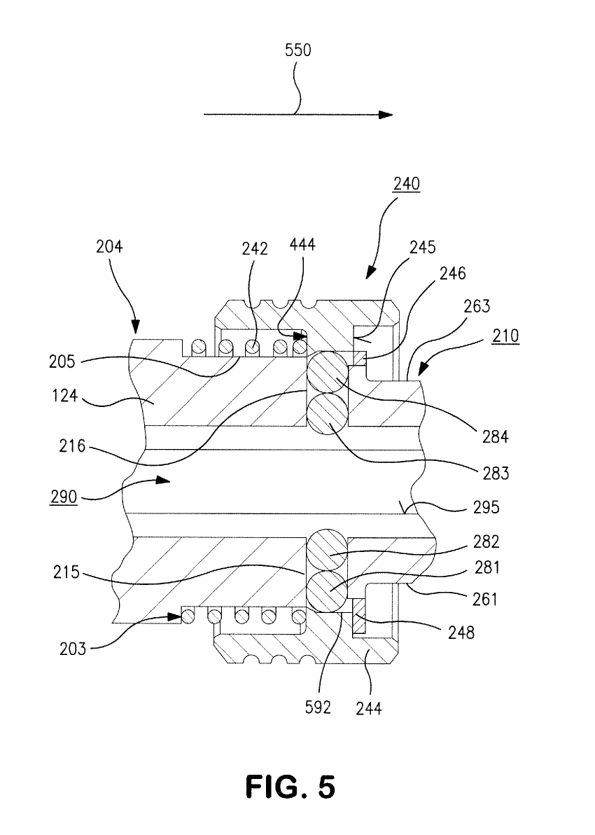

For example, the locking device 240 is equipped with the actuating sleeve 244, a compression spring 242, a retaining element 246 embodied for example in the form of a C-ring, and four balls 281, 282, 283, 284; the balls 281, 282 can be inserted into the opening 215 of the output shaft 124 and the balls 283, 284 can be inserted into the opening 216. The balls 281, 282, 283, 284 are held in the openings 215 and 216 by the actuating sleeve 244 that can be slid onto the output shaft 124 in the direction toward the output cam 208, as depicted below in FIG. 5.

In a sample mounting of the locking device 240 on the tool holder 150 or output shaft 124, after the balls 281, 282, 283, 284 are inserted into the openings 215 and 216, first the compression spring 242, then the actuating sleeve 244 provided with a collar-like supporting element 245, and finally the retaining C-ring 246 provided with the radial extensions 247, 248, 249 are slid onto the output shaft 124 in the direction toward the output cam 208 so that the retaining C-ring 246 engages in the groove-like recesses 288, 289, 286 (FIG. 3), and 287 (FIG. 3). Consequently, the radial extensions 247, 248, 249 block the collar-like supporting element 245 so that the locking device 240 is immobilized on the output shaft 124.

FIG. 3 shows the arrangement 200 from FIG. 2 after assembly of the locking device 240 on the tool holder 150 or output shaft 124. FIG. 3 shows the radial extensions 247, 249 of the retaining C-ring 246 situated between the second shoulder 206 and the groove-like recesses 276, 287, 288, 289 against which, in the locking position, the collar-like supporting element 245 of the actuating sleeve 244 rests and is pressed by the compression spring 242 (FIG. 2), as described below in conjunction with FIG. 5.

In addition, FIG. 3, as described above in conjunction with FIG. 2, shows an opening 273 with a conical section 274 provided in the side surface 263, which is situated opposite the opening 271 in the side surface 261, and a beveled edge 256 that connects the surfaces 263 and 264 and has an end surface 257 beveled toward the distal end region 201 of the output shaft 124. FIG. 3 also shows the ball 282 that is pressed radially inward at least partway through the opening 215 into the hexagonal internal socket 290, for example.

FIG. 4 shows the arrangement 200 from FIG. 3 in connection with an insert bit 510 that has an internal multisided coupling 514, depicted in the form of an internal four-sided coupling as an illustrative example, provided with openings 575, 576. According to one embodiment, this insert bit is a socket wrench embodied in accordance with Japanese industrial standards, equipped with a multisided working interface 520, for example with a twelve-sided working interface. A socket wrench of this kind is sufficiently known from the prior art so that for the sake of brevity, a detailed description is not given here.

According to one embodiment, to fasten the socket wrench 510, it is slid onto the tool holder 150 in the direction of an arrow 410 until the openings 575, 576 are congruent with the openings 273 and 271 of the fastening element 250. This is preferably the case when the socket wrench 510 is resting with an end section 525 against the retaining C-ring 246. Then, a pin 530 is inserted into the congruent openings 575, 273 and 576, 271 and is fixed in place therein by means of an associated O-ring 535, e.g. a rubber ring. This achieves a detachable fastening of the socket wrench 510 to the tool holder 150.

In FIG. 4, the actuating sleeve 244 is shown for example in the unlocking position in which, for the removal or withdrawal of the screwdriver bit 140 from FIG. 1, the balls 281, 282, 283, 284 can move radially outward and consequently release their engagement in an external annular groove provided—for example in accordance with DIN 3126-E6.3—on the outer hexagonal coupling 142 of the screwdriver bit 140 from FIG. 1. For this purpose, in opposition to the force of the compression spring 242, which is situated, as an illustrative example, between the first shoulder 203 and a collar-like projection 444 embodied for example on the inside of the actuating sleeve 244, the actuating sleeve 244 is slid axially in the direction of the arrow 410, thus releasing the balls 281, 282, 283, 284.

FIG. 5 shows an enlargement of a detail labeled V in FIG. 4 in the locking position in which the compression spring 242 resting against the collar-like projection 444 acts on the actuating sleeve 244 with its predetermined spring force in the direction of an arrow 550. This presses the actuating sleeve 244, as depicted in FIG. 3, with its collar-like supporting element 245 in the direction of the arrow 550 against the retaining C-ring 246 or its radial extension 248 (as well as the radial extensions 247 and 249 from FIG. 3).

A preferably annularly embodied collar 592 is provided between the collar-like supporting element 245 and the collar-like projection 444. It blocks the balls 281, 282, an 283, 284, which have been pressed radially inward into the openings 215, 216, in the locked position in order to lock the screwdriver bit 140 from FIG. 1 in the hexagonal internal socket 290.

The foregoing relates to preferred exemplary embodiments of the invention, it being understood that other variants and embodiments thereof are possible within the spirit and scope of the invention, the latter being defined by the appended claims.

1. A hand-held power tool having:
a tool holder, equipped with a multisided internal socket for connecting to a first insert bit and with a multisided external socket for connecting to a second insert bit; and
a locking device being associated with the tool holder, for locking the first insert bit in the multisided internal socket, the locking device having an actuating element which is possible to slide from a locking position into an unlocking position in an axial direction oriented away from the first insert tool in order to unlock the first insert tool.

2. The hand-held power tool according to claim 1, wherein locking device has a spring element that is embodied to act on the actuating element toward the locking position with a predetermined spring force in a direction of the first insert bit.

3. The hand-held power tool according to claim 1, wherein the actuating element has an actuating sleeve that at least partially encompasses the tool holder.

4. The hand-held power tool according to claim 2, wherein the locking device has a retaining element that is embodied to block the actuating element, which is acted on by the spring element with the predetermined spring force, in the locking position during operation of the hand-held power tool.

5. The hand-held power tool according to claim 3, wherein the locking device has a retaining element that is embodied to block the actuating element, which is acted on by the spring element with the predetermined spring force, in the locking position during operation of the hand-held power tool.

6. The hand-held power tool according to claim 4, wherein the retaining element is embodied in the form of a C-ring that has radial extensions for blocking the actuating element.

7. The hand-held power tool according to claim 5, wherein the retaining element is embodied in the form of a C-ring that has radial extensions for blocking the actuating element.

8. The hand-held power tool according to claim 6, wherein the actuating element has a collar-like supporting element, which, in the locking position, rests against the radial extensions of the retaining element.

9. The hand-held power tool according to claim 7, wherein the actuating element has a collar-like supporting element, which, in the locking position, rests against the radial extensions of the retaining element.

10. The hand-held power tool according to claim 2, wherein spring element is situated between a shoulder, which is associated with the tool holder, and at least one projection provided on the actuating element.

11. The hand-held power tool according to claim 3, wherein spring element is situated between a shoulder, which is associated with the tool holder, and at least one projection provided on the actuating element.

12. The hand-held power tool according to claim 4, wherein spring element is situated between a shoulder, which is associated with the tool holder, and at least one projection provided on the actuating element.

13. The hand-held power tool according to claim 5, wherein spring element is situated between a shoulder, which is associated with the tool holder, and at least one projection provided on the actuating element.

14. The hand-held power tool according to claim 2, wherein the locking device has at least one locking element, which, in the locking position, is acted on by the actuating element in a direction toward the multisided internal socket in order to lock the first insert bit.

15. The hand-held power tool according to claim 12, wherein the locking device has at least one locking element, which, in the locking position, is acted on by the actuating element in a direction toward the multisided internal socket in order to lock the first insert bit.

16. The hand-held power tool according to claim 13, wherein the locking device has at least one locking element, which, in the locking position, is acted on by the actuating element in a direction toward the multisided internal socket in order to lock the first insert bit.

17. The hand-held power tool according to claim 14, wherein the at least one locking element is preferably embodied to engage in an external groove-like recess in the first insert bit, the recess being provided on an external multisided coupling of the first insert bit, which can be slid into the multisided internal socket of the tool holder.

18. The hand-held power tool according to claim 17, wherein the at least one locking element is embodied in the form of a ball.

19. The hand-held power tool according to claim 1, wherein the multisided external socket has a fastening element to which the second insert bit, which is provided with an internal multisided coupling, is fastenable via an associated pin.

20. A tool holder having:
a multisided internal socket for connecting to a first insert bit and a multisided external socket for connecting to a second insert bit; and
a locking device being associated with the tool holder for locking the first insert bit in the multisided internal socket, the locking device having an actuating element that has a capacity to be slid from a locking position into an unlocking position in an axial direction oriented away from the first insert tool in order to unlock the first insert tool.
